(19) United States
(12) Patent Application Publication
(10) Pub. No.: US 2014/0219875 A1
(43) Pub. Date: Aug. 7, 2014

(54) GRAPHITE MANUFACTURING APPARATUS

(71) Applicant: HUGETEMP ENERGY LTD., Hsinchu County (TW)

(72) Inventor: HAN-TANG YANG, HSINCHU COUNTY (TW)

(73) Assignee: Hugetemp Energy Ltd., Hsinchu County (TW)

(21) Appl. No.: 13/864,388

(22) Filed: Apr. 17, 2013

(30) Foreign Application Priority Data
Feb. 5, 2013 (TW) 102202433

(51) Int. Cl. B01J 19/24

(52) U.S. Cl. CPC B01J 19/24
USPC 422/112; 422/187

(57) ABSTRACT

A graphite manufacturing apparatus includes a furnace body, an exhaust pipe, a waste oil tank and a suction pump. The exhaust pipe is connected to the furnace body and communicates with the furnace body to discharge a waste gas of the furnace body. The waste oil tank communicates with the exhaust pipe to absorb waste oil of the waste gas and to filter the waste oil. The suction pump is connected with the waste oil tank and communicates with the waste oil tank, the exhaust pipe and the furnace body so as to suck the waste gas of the furnace body to the waste oil tank and to discharge a gas filtered by the waste oil tank. The present invention can decrease the amount of the waste oil of the waste gas and prolongs the service life of the suction pump.

### BACKGROUND OF THE INVENTION

1. Field of the Invention

The present invention relates to a graphite manufacturing apparatus, and more particularly to a graphite manufacturing apparatus having an exhaust system to absorb waste oil so as to prolong the service life of a suction pump.

2. Description of the Prior Art

Graphitization is a process technique to transform macromolecular compounds into graphite. The carbonaceous material of the organic compound is heated to evaporate its low molecular compound. Over a certain temperature, thermal decomposition will dissociate carbon bounds to low molecular compounds by fractional distillation. When at a high temperature, carbon will crystallize to become graphite.

A conventional graphite manufacturing apparatus usually uses resistance heating. However, it needs a long period of time to rise the temperature and it will discharge carbon dioxide during manufacturing process. Therefore, it doesn't conform to the demand of environmental protection. Taiwan Patent Publication No. 514240 discloses an induction heating furnace of a graphitization device to produce small-scale graphite. A graphite crucible is used to load carbonaceous materials. An induction coil made of copper is used for heating. For graphitization of carbonaceous materials, non-airtight oxidation protection is taken. However, the apparatus of Patent Publication No. 514240 is only for small-scale production, not for mass production. Because the graphite has electric conductivity, the graphite crucible needs to be insulated from the induction coil and the induction heating apparatus must enhance its efficiency. Besides, the apparatus of Patent Publication No. 514240 uses a magnesium oxide insulation layer and a non-airtight furnace. At a high temperature with air, magnesium oxide may burn easily to influence the safety.

Taiwan Patent Publication No. 398536 owned by the applicant discloses a graphite manufacturing apparatus for mass production. This apparatus is safe and conforms to the demand of environmental protection to solve the problems of the apparatus of Patent Publication No. 514240. However, in practice, the graphitization material will generate waste gas and waste oil during heating process, such as tar. The waste gas contains the waste oil. The waste gas will be discharged through an exhaust system, and the waste oil will attach to a suction pump of the exhaust system. This will shorten the efficiency and service life of the suction pump greatly to increase the cost. Besides, the temperature measuring device of the conventional manufacturing apparatus is easily influenced by the surrounding heat radiation temperature of a measure hole of the temperature measuring device and the smoke surrounding the temperature measuring area to cause that the accuracy of temperature measure is not good. The temperature of the furnace cannot be controlled exactly to influence the quality of graphite. Accordingly, the inventor of the present invention has devoted himself based on his many years of practical experiences to solve these problems.

### SUMMARY OF THE INVENTION

The primary object of the present invention is to provide a graphite manufacturing apparatus which comprises a furnace body, an exhaust system at one side of the furnace body, and a waste oil tank to absorb waste oil of the waste gas so as to decrease the amount of the waste oil of the waste gas and to prolong the service life of an suction pump.

Another object of the present invention is to provide a graphite manufacturing apparatus which comprises an inert gas inlet disposed on the top of the furnace body. The specific gravity of the inert gas is greater than that of the air so the air will ascend when pouring the inert gas. This is beneficial for the exhaust system to discharge the air out of the furnace body.

A further object of the present invention is to provide a graphite manufacturing apparatus which comprises a temperature measuring device and an inert gas inlet disposed on the top of the furnace body. The inert gas from the inert gas inlet will pass the underside of the temperature measuring device to enter the furnace body to lower the surrounding heat radiation temperature of a measure hole of the temperature measuring device. The inert gas also blows away the smoke surrounding the temperature measuring area so the accuracy of temperature measure won't be influenced.

A further object of the present invention is to provide a graphite manufacturing apparatus which comprises a pressure detection device to detect the pressure of the furnace body in order to adjust the amount of the inert gas to enter the furnace body or to discharge from the furnace body. This can prevent the pressure of the furnace body from being too large to ensure the safety.

The present invention discloses a graphite manufacturing apparatus which comprises a furnace body; an exhaust pipe, the exhaust pipe being connected to the furnace body and communicating with the furnace body to discharge a waste gas of the furnace body; a waste oil tank, the waste oil tank communicating with the exhaust pipe to absorb waste oil of the waste gas and to filter the waste oil; and a suction pump, the suction pump being connected with the waste oil tank and communicating with the waste oil tank, the exhaust pipe and the furnace body so as to suck the waste gas of the furnace body to the waste oil tank and to discharge a gas filtered by the waste oil tank. By such a configuration, the waste gas of the furnace body can be discharged and filtered so as to prolong the service life of the suction pump.

### BRIEF DESCRIPTION OF THE DRAWINGS

FIG. 1 is a schematic view of the present invention;

FIG. 2 is a schematic view showing the furnace body of the present invention;

FIG. 3 is a schematic view showing the waste oil tank of the present invention; and

FIG. 4 is a schematic view showing the position of the flow valve of the present invention.

### DETAILED DESCRIPTION OF THE PREFERRED EMBODIMENTS

Embodiments of the present invention will now be described, by way of example only, with reference to the accompanying drawings.

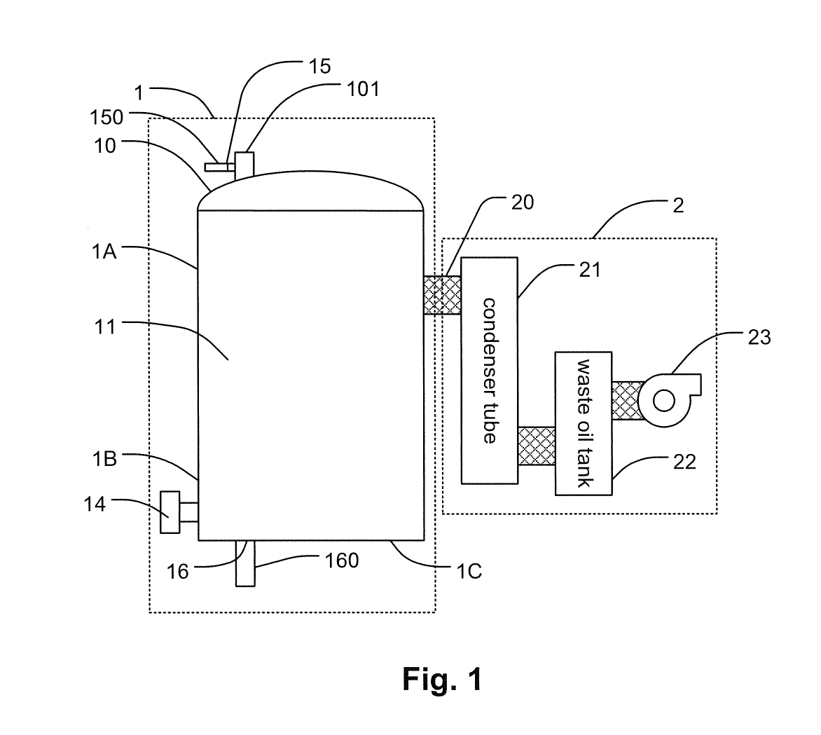

Referring to FIG. 1, the graphite manufacturing apparatus of the present invention comprises a furnace body 1 and an exhaust system 2. The exhaust system 2 comprises an exhaust pipe 20, a condenser tube 21, a waste oil tank 22, and a suction pump 23.

The furnace body 1 and the exhaust system 2 are connected. The exhaust pipe 20 of the exhaust system 2 is connected to the furnace body 1 and communicates with the inside of the furnace body 1 to exhaust the waste gas in the furnace body 1. The condenser tube 21 is connected with the exhaust pipe 20 so that the waste gas can enter the condenser tube 21. The condenser tube 21 is used to condense the waste gas. The waste oil tank 22 is connected with the condenser tube 21 and used to absorb the waste oil contained in the waste gas after condensation to filter the waste gas. The suction pump 23 is connected with the waste oil tank 22. Through the waste oil tank 22, the condenser tube 21 and the exhaust pipe 20, the waste gas in the furnace body 1 is drawn to the waste oil tank 22 for filtration, and then the filtered gas is discharged.

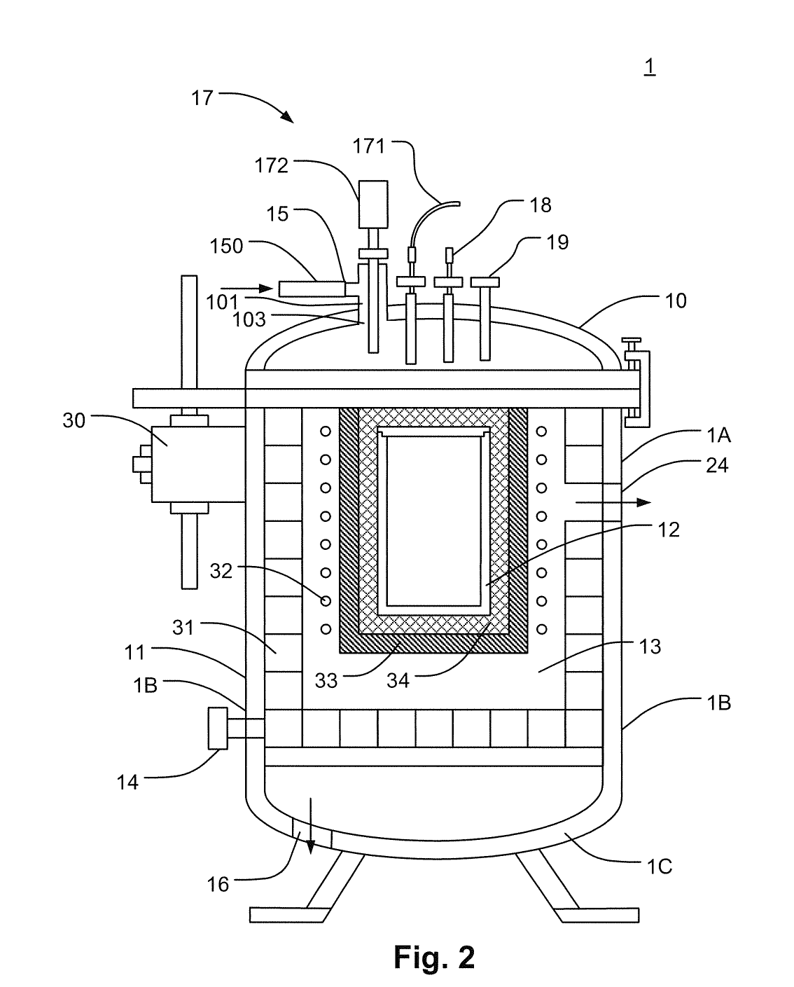

In the embodiment of the present invention, the furnace body 1 is a cylindrical furnace body, and has an outer casing 11 and an upper cover 10. The outer casing 11 has an accommodation room 13 therein, as shown in FIG. 2. The upper cover 10 is disposed on top of the outer casing 11 to seal the top of the outer casing 11. The outer casing 11 is divided into an upper wall portion 1A, a lower wall portion 1B and a bottom 10 from top to bottom. The hollow inside of the furnace body 1, referring to FIG. 2, is defined as the accommodation room 13. A graphite crucible 12 is provided in the accommodation room 13 to load a raw material for manufacturing graphite.

FIG. 2 shows the configuration of the furnace body 1 of the present invention. One side of the outer casing 11 is provided with a lift mechanism 30 to open/close the upper cover 10. The outer casing 11 comprises a thermal insulation layer 31 attached to an inner wall thereof. The thermal insulation layer 31 is composed of steel jade bricks to prevent the outer casing 11 from generating an induced current and heating and to insulate the heat of the graphite crucible 12 from being transmitted to the outer casing 11. This prevents high temperature of the outer casing 11 and the user won't be hurt. Besides, the thermal energy can be kept to maintain the high temperature in the accommodation room 13 so as to enhance heating efficiency.

As to the graphitization processing, the graphite crucible 12 is wrapped with a thermal blanket 34. The thermal blanket 34 is wrapped with an insulating ceramic sleeve 33. The insulating ceramic sleeve 33 is surrounded with an induction coil 32. The thermal blanket 34 is made of a mixture of graphite fibers and carbon fibers to cover the graphite crucible 12 so that the graphite crucible 12 can be effectively insulated from heat exchange with the external environment for energy saving. The insulating ceramic sleeve 33 fitted on the thermal blanket 34 is to prevent the graphite fibers of the thermal blanket 34 from entering the induction coil 32 because the graphite fibers will cause that the electric induction coil 32 and the graphite crucible 12 will generate electric arc. The insulating ceramic sleeve 33 also enhances the thermal effect for the graphite crucible 12 to save energy effectively. In the embodiment of the present invention, the insulating ceramic sleeve 33 contains aluminum oxide and zirconium oxide. At a high temperate, the insulating ceramic sleeve 33 won't break to pieces so it can prevent graphite fibers from penetrating so as to ensure the insulation function.

The induction coil 32 surrounding on the insulating ceramic sleeve 33 is connected with a power system (not shown in the drawings). In this embodiment, the induction coil 32 is made of a copper pipe having cooling water therein. The power system provides the required power to the induction coil 32. The power system transforms three-phase alternating current into 500˜5000 Hz intermediate frequency direct current. By the induction coil 32, the inside of the graphite crucible 12 generates trickle. Through the trickle, the inside of the graphite crucible 12 is circulated to generate heat, so that the working temperature of the graphite crucible 12 can reach 1500˜3200□ in 80˜250 minutes.

The present invention uses polyimide (PI) as the raw material for graphitization. The PI polymeric membrane is placed in the graphite crucible 12 and heated to 2800□ for the raw material to be graphitized. During the process, about 1000□, it will generate a large number of impurities and waste oil, such as tar. The exhaust system 2 of the present invention dissociates the impurities and waste oil in the form of waste gas. However, when the temperate is about 3000□, it is not necessary to extract air because the impurity is less in this phase.

Through the suction pump 23 at one end of the exhaust system 2, the waste gas is drawn to the exhaust pipe 20 of the exhaust system 2 from an outlet 24 of the accommodation room 13, and then enters the condenser tube 21 and the waste oil tank 22 in sequence. Finally, the waste gas is discharged through the suction pump 23.

During the heating process of graphitization, in order to clear the impurities and waste oil, the suction pump 23 will draw out the gas in the accommodation room 13. The gas mixes with the impurities and waste oil to form waste gas. The waste gas will be condensed with the moisture in the condenser pipe 21, preventing the moisture from having a hand in the graphitization to cause unnecessary reaction. Except the moisture, if the waste gas mixed with the waste oil is sent to the suction pump 23, the suction pump 23 will be damaged.

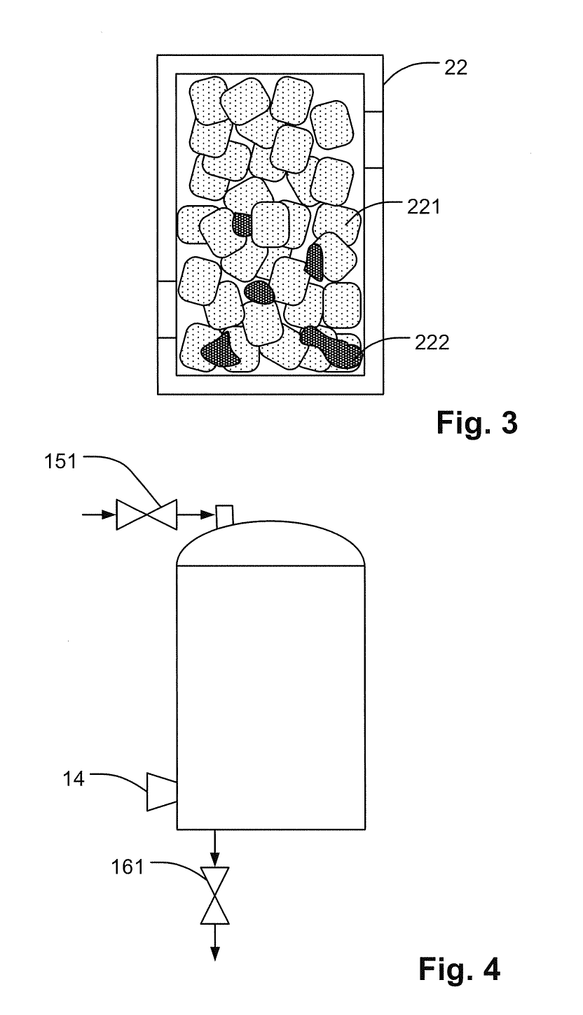

The waste oil tank 22 of the present invention is disposed between the condenser pipe 21 and the suction pump 23 to absorb the waste oil in the waste gas and to filter the waste gas and other impurities, preventing the waste oil and impurities from entering the suction pump 23. This ensures the gas to the suction pump 23 is clean gas. Referring to FIG. 3, the waste oil tank 22 comprises a plurality of porous ceramic rings 221 therein. By the pores of the porous ceramic rings 221, the waste oil 222 certainly stays in the waste oil tank 22. Through the porous ceramic rings 221, the waste oil 222 can be cleared.

The present invention improves not only the exhaust system 2 but also air flow of the furnace body 1. The exhaust pipe 20 of the exhaust system 2 of the present invention is connected to the upper wall portion 1A of the outer casing 11 for the waste gas to be discharged well. The upper cover 10 of the present invention has a space which communicates with the accommodation room 13 of the furnace body 11. The upper cover 10 further has an inert gas inlet 15, as shown in FIG. 2. The inert gas inlet 15 is connected with an inert gas pipe 150, namely, the upper cover 10 is connected with the inert gas pipe 150 for the inert gas to enter the accommodation room 13, preventing external oxygen from entering the accommodation room 13 to react with the raw material. In addition, as shown in FIG. 1, the bottom 10 of the outer casing 11 of the present invention has an inert gas outlet 16 which is connected with an inert gas exhaust pipe 160 so as to form the flow path of the inert gas.

The specific gravity of the inert gas is greater than that of the air. After the inert gas enters the accommodation room 13, the inert gas will sink to be in the furnace body 1, that is to say, the air at the bottom of the accommodation room 13 will rise to approach the outlet 24 of the exhaust system 2. This assists the exhaust system 2 in drawing the air. Through the inert gas outlet 16 at the bottom 10 of the outer casing 11, the inert gas can be discharged.

Referring to FIG. 4, the present invention further comprises a flow valve 151 which can be disposed at the inert gas inlet 15 or the inert gas pipe 150 as shown in FIG. 2. The flow valve 151 is used to control the amount of the inert gas in the inert gas pipe 150 to enter the accommodation room 13. When the internal pressure of the furnace body 1 is too large, the flow valve 151 can close the inert gas pipe 150 to stop the inert gas so as to prevent the structure from being damaged. After the internal pressure returns to the standard, the inert gas pipe 150 is opened again for the inert gas to enter the accommodation room 13 of the furnace body 1.

The flow valve 151 is adapted to control the inert gas to enter the furnace body 1. The present invention may comprise a flow valve 161 at the inert gas outlet 16 or the inert gas exhaust pipe 160, as shown in FIG. 1. The flow valve 161 is adapted to control the inert gas outlet 16 or the inert gas exhaust pipe 160 to discharge the inert gas. When the internal pressure is too large, the inert gas can be controlled to discharge quickly.

As shown in FIG. 2, the outer casing 11 of the present invention comprises an anti-explosion valve 14 at the lower wall portion 1B of the outer casing 11 as a safety apparatus in an emergency. The anti-explosion valve 14 communicates with the accommodation room 13. When the internal pressure of the accommodation room 13 is too large, the pressure will make the anti-explosion valve 14 explode to release pressure, preventing the whole furnace body 1 from exploding so as to ensure safety when in use. In an embodiment of the present invention, the anti-explosion valve 14 is a mechanical anti-explosion valve.

Referring to FIG. 2, the upper cover 10 of the present invention further comprises a temperature measuring device 17. The temperature measuring device 17 extends into the graphite crucible 12 of the accommodation room 13 to measure the temperature of the graphite crucible 12. The temperature measuring device 17 comprises a thermocouple measuring device 171 and an infrared measuring device 172. When the temperature is under 1000□, the thermocouple measuring device 171 extends into the graphite crucible 12 to measure the temperature. When the temperature is close to 1000□, the thermocouple measuring device 171 is taken out and the infrared measuring device 172 is used to measure the temperature above 1000□ to ensure accuracy of temperature measurement. The upper cover 10 of the present invention further comprises a pipe 101. The pipe 101 communicates with the inside of the upper cover 10 and the accommodation room 13. The infrared measuring device 172 is inserted in the pipe 101 to measure the temperature of the graphite crucible 12. The thermocouple measuring device 171 can be inserted in the pipe 101 to measure the temperature of the graphite crucible 12. When the temperature measuring device 17 is inserted in the pipe 101, the temperature measuring device 17 will seal the upper end of the pipe 101.

The inert gas inlet 15 is disposed on the side wall of the pipe 101 and the inert gas pipe 150 is connected to the inert gas inlet 15, that is, the inert gas pipe 150 is connected to the upper cover 10. Because the inert gas inlet 15 is disposed on the pipe 101, when the inert gas flows to the pipe 101 from the inert gas inlet 15 and enters the accommodation room 13 through the upper cover 10, the inert gas will pass the underside of the temperature measuring device 17 to lower the surrounding heat radiation temperature of a measure hole 103. The inert gas also blows away the smoke surrounding the temperature measuring area so the accuracy of temperature measure won't be influenced. In another embodiment of the present invention, the inert gas inlet 15 may be direct formed on the upper cover 10. The inert gas from the inert gas inlet 15 will pass the underside of the temperature measuring device 17 to enter the accommodation room 13.

The upper cover 10 is provided with a pressure detection device 18. The pressure detection device 18 is disposed on the upper cover 10 and extends into the accommodation room 13 to detect the pressure of the accommodation room 13 and to send out a pressure signal. The pressure signal is transmitted to an external monitor system to show the pressure value of the accommodation room 13 for the operator to monitor. The flow valve 151, 161 can be an electronic flow valve to receive the signal of the pressure detection device 18 to adjust the amount of the inert gas to enter the accommodation room 13 or to discharge from the accommodation room 13. That is, the flow valve 151 adjusts the amount of the inert gas to enter the accommodation room 13 according to the pressure signal, and the flow valve 161 adjusts the amount of the inert gas to discharge from the accommodation room 13 according to the pressure signal. Furthermore, the upper cover 10 has a monitor window 19 which penetrates the upper cover 10. The top ends of the graphite crucible 12 and the thermal blanket 34 has through holes (not shown in the drawings) corresponding in position to the monitor window 19. Through the monitor window 19, the operator can observe the reacting state of the raw materials.

The apparatus of the present invention can be widely used to graphitization for various carbon powder, carbon fiber, graphite membrane or graphite block. The carbon powder, carbon fiber, graphite membrane or graphite block can be further processed to develop novel products, such as Thermal Flexible Graphite, GTS. The unique crystalline graphite material is adapted for even heat conduction, the lamellar configuration can be applied to any surface to improve and enhance the function of various electric products.

The graphite manufacturing apparatus of the present invention has many advantages. During the process of graphitization, a large amount of waste oil will be discharged and the waste oil may damage the suction pump so the present invention provides the waste oil tank to overcome this problem. Through circulation of the inert gas, the efficiency of the exhaust system is increased. The valves to control the air pressure of the furnace body are to ensure the safety and convenient operation. The graphite manufacturing apparatus of the present invention is economical and practical.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A graphite manufacturing apparatus, comprising:
a furnace body;
an exhaust pipe, the exhaust pipe being connected to the furnace body and communicating with the furnace body to discharge a waste gas of the furnace body;
a waste oil tank, the waste oil tank communicating with the exhaust pipe to absorb waste oil of the waste gas and to filter the waste oil; and
a suction pump, the suction pump being connected with the waste oil tank and communicating with the waste oil tank, the exhaust pipe and the furnace body so as to draw the waste gas of the furnace body to the waste oil tank and to discharge a gas filtered by the waste oil tank.

2. The graphite manufacturing apparatus as claimed in claim 1, wherein the waste oil tank comprises a plurality of porous ceramic rings therein.

3. The graphite manufacturing apparatus as claimed in claim 1, further comprising a condenser tube, the condenser tube being connected with the exhaust pipe and the waste oil tank, the condenser tube being adapted to condense the waste gas, the waste oil tank absorbing the waste oil of the waste gas after condensed.

4. The graphite manufacturing apparatus as claimed in claim 1, wherein the furnace body comprises:
an outer casing, the outer casing having an accommodation room therein;
an upper cover, the upper cover being disposed on top of the outer casing; and
a graphite crucible, the graphite crucible being disposed in the accommodation room to load a raw material for manufacturing graphite and to generate the waste gas.

5. The graphite manufacturing apparatus as claimed in claim 4, wherein the furnace body further comprises a thermal blanket to wrap the graphite crucible.

6. The graphite manufacturing apparatus as claimed in claim 5, wherein the furnace body further comprises an insulating ceramic sleeve to wrap the thermal blanket and an induction coil surrounding the insulating ceramic sleeve.

7. The graphite manufacturing apparatus as claimed in claim 4, wherein the furnace body further comprises a thermal insulation layer disposed on an inner wall of the outer casing.

8. The graphite manufacturing apparatus as claimed in claim 4, wherein the upper cover is connected with an inert gas pipe for pouring inert gas into the accommodation room.

9. The graphite manufacturing apparatus as claimed in claim 8, wherein the upper cover is provided with a temperature measuring device, the temperature measuring device extending into the graphite crucible to measure the temperature of the graphite crucible, the inert gas from the inert gas pipe passing an underside of the temperature measuring device to enter the accommodation room.

10. The graphite manufacturing apparatus as claimed in claim 8, wherein the inert gas pipe is provided with a flow valve to control the amount of the inert gas to enter the accommodation room.

11. The graphite manufacturing apparatus as claimed in claim 10, wherein the upper cover is provided with a pressure detection device, the pressure detection device extending into the accommodation room to detect the pressure of the accommodation room and to send out a pressure signal, the flow valve adjusting the amount of the inert gas to enter the accommodation room according to the pressure signal.

12. The graphite manufacturing apparatus as claimed in claim 8, wherein a bottom of the furnace body has an inert gas outlet to discharge the inert gas of the accommodation room.

13. The graphite manufacturing apparatus as claimed in claim 12, wherein the inert gas outlet is provided with a flow valve to control the amount of the inert gas to be discharged.

14. The graphite manufacturing apparatus as claimed in claim 13, wherein the upper cover is provided with a pressure detection device, the pressure detection device extending into the accommodation room to detect the pressure of the accommodation room and to send out a pressure signal, the flow valve adjusting the amount of the inert gas to be discharged according to the pressure signal.

15. The graphite manufacturing apparatus as claimed in claim 1, wherein the furnace body comprises an anti-explosion valve at a lower side thereof.
